(19) United States
(12) Patent Application Publication
(10) Pub. No.: US 2024/0232653 A1
(43) Pub. Date: Jul. 11, 2024

(54) SYSTEM FOR IMPLEMENTING PREDICTIVE CONFIGURATION CHANGES BASED ON TRACKING APPLICATION USAGE PATTERNS

(71) Applicant: BANK OF AMERICA CORPORATION, Charlotte, NC (US)

(72) Inventors: Michael G. Horstman, Chicago, IL (US); Ganesh Bonda, Charlotte, NC (US); Manu Jacob Kurian, Dallas, TX (US)

(73) Assignee: BANK OF AMERICA CORPORATION, Charlotte, NC (US)

(21) Appl. No.: 18/095,302

(22) Filed: Jan. 10, 2023

(51) Int. Cl. G06N 5/022

(52) U.S. Cl. CPC G06N 5/022

(57) ABSTRACT

A system is provided for implementing predictive configuration changes based on tracking application usage patterns. In particular, the system may track usage patterns associated with a user and predict the intention of the user based on the usage patterns. For instance, the system may track resource transfers executed by the user within the application and generate one or more configuration changes for user account linkages with external entity computing systems or servers. Once the configuration changes have been generated, the system may prompt the user with a notification to accept the changes. Upon receiving an acceptance from the user, the system may dynamically and automatically implement the configuration changes. In this way, the system may provide an efficient way to generate and implement configuration changes based on tracking application usage.

### FIELD OF THE INVENTION

The present invention embraces a system for implementing predictive configuration changes based on tracking application usage patterns.

### BACKGROUND

There is a need for an intelligent, automated way to suggest and implement configuration changes based on predictive pattern analysis.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

A system is provided for implementing predictive configuration changes based on tracking application usage patterns. In particular, the system may track usage patterns associated with a user (e.g., within an application) and predict the intention of the user based on the usage patterns. For instance, the system may track resource transfers executed by the user within the application and generate one or more configuration changes for user account linkages with external entity computing systems or servers. Once the configuration changes have been generated, the system may prompt the user with a notification to accept the changes. Upon receiving an acceptance from the user, the system may dynamically and automatically implement the configuration changes. In this way, the system may provide an efficient way to generate and implement configuration changes based on tracking application usage.

Accordingly, embodiments of the present disclosure provide a system for implementing predictive configuration changes based on tracking application usage patterns, the system comprising at least one non-transitory storage device; and at least one processor coupled to the at least one non-transitory storage device, wherein the at least one processor is configured to continuously monitor, using an intelligent prediction engine, application usage data associated with an application installed on an endpoint device associated with a user; train a machine learning model of the intelligent prediction engine using the application usage data; based on training the machine learning model, identify one or more inefficiencies in a workflow of the user within the application; based on identifying the one or more inefficiencies, generate one or more configuration changes for addressing the one or more inefficiencies; transmit a notification comprising the one or more configuration changes to the endpoint device, wherein the notification further comprises an interactable element associated with the one or more configuration changes; detect that the user has activated the interactable element; and automatically implement the one or more configuration changes.

In some embodiments, identifying the one or more inefficiencies in the workflow of the user comprises feeding the application usage data into the intelligent prediction engine; based on the application usage data, determining a most efficient process flow for accomplishing an intended action of the user within the application; and comparing the most efficient process flow with the workflow of the user.

In some embodiments, the application usage data comprises information on application functions accessed by the user, which interface elements the user has interacted with, and what timeframes in which the user has accessed the application.

In some embodiments, the one or more inefficiencies in the workflow comprises a disabled application setting, wherein the one or more configuration changes comprises automatically enabling the application setting.

In some embodiments, the application is a resource management application, wherein the intelligent prediction engine is further configured to monitor resource account data associated with the user.

In some embodiments, the resource account data comprises resource transfer data, the resource transfer data comprising resource transfer amounts, recipient data, and resource transfer timeframes.

In some embodiments, the notification further comprises a prompt for the user to accept the one or more configuration changes.

Embodiments of the present disclosure also provide a computer program product for implementing predictive configuration changes based on tracking application usage patterns, the computer program product comprising a non-transitory computer-readable medium comprising code causing an apparatus to continuously monitor, using an intelligent prediction engine, application usage data associated with an application installed on an endpoint device associated with a user; train a machine learning model of the intelligent prediction engine using the application usage data; based on training the machine learning model, identify one or more inefficiencies in a workflow of the user within the application; based on identifying the one or more inefficiencies, generate one or more configuration changes for addressing the one or more inefficiencies; transmit a notification comprising the one or more configuration changes to the endpoint device, wherein the notification further comprises an interactable element associated with the one or more configuration changes; detect that the user has activated the interactable element; and automatically implement the one or more configuration changes.

In some embodiments, identifying the one or more inefficiencies in the workflow of the user comprises feeding the application usage data into the intelligent prediction engine; based on the application usage data, determining a most efficient process flow for accomplishing an intended action of the user within the application; and comparing the most efficient process flow with the workflow of the user.

In some embodiments, the application usage data comprises information on application functions accessed by the user, which interface elements the user has interacted with, and what timeframes in which the user has accessed the application.

In some embodiments, the one or more inefficiencies in the workflow comprises a disabled application setting, wherein the one or more configuration changes comprises automatically enabling the application setting.

In some embodiments, the application is a resource management application, wherein the intelligent prediction engine is further configured to monitor resource account data associated with the user.

In some embodiments, the resource account data comprises resource transfer data, the resource transfer data comprising resource transfer amounts, recipient data, and resource transfer timeframes.

Embodiments of the present disclosure also provide a computer-implemented method for implementing predictive configuration changes based on tracking application usage patterns, the computer-implemented method comprising continuously monitoring, using an intelligent prediction engine, application usage data associated with an application installed on an endpoint device associated with a user; training a machine learning model of the intelligent prediction engine using the application usage data; based on training the machine learning model, identifying one or more inefficiencies in a workflow of the user within the application; based on identifying the one or more inefficiencies, generating one or more configuration changes for addressing the one or more inefficiencies; transmitting a notification comprising the one or more configuration changes to the endpoint device, wherein the notification further comprises an interactable element associated with the one or more configuration changes; detecting that the user has activated the interactable element; and automatically implementing the one or more configuration changes.

In some embodiments, identifying the one or more inefficiencies in the workflow of the user comprises feeding the application usage data into the intelligent prediction engine; based on the application usage data, determining a most efficient process flow for accomplishing an intended action of the user within the application; and comparing the most efficient process flow with the workflow of the user.

In some embodiments, the application usage data comprises information on application functions accessed by the user, which interface elements the user has interacted with, and what timeframes in which the user has accessed the application.

In some embodiments, the one or more inefficiencies in the workflow comprises a disabled application setting, wherein the one or more configuration changes comprises automatically enabling the application setting.

In some embodiments, the application is a resource management application, wherein the intelligent prediction engine is further configured to monitor resource account data associated with the user.

In some embodiments, the resource account data comprises resource transfer data, the resource transfer data comprising resource transfer amounts, recipient data, and resource transfer timeframes.

In some embodiments, the notification further comprises a prompt for the user to accept the one or more configuration changes.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIGS. 1A-1C illustrates technical components of an exemplary distributed computing environment for the system for implementing predictive configuration changes based on tracking application usage patterns, in accordance with an embodiment of the present disclosure; and

FIG. 2 illustrates a process flow for implementing predictive configuration changes based on tracking application usage patterns, in accordance with an embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (“GUI”) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally-controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, “resource” may generally refer to physical or virtual objects that may be used to accomplish the entity's objectives. In this regard, the resources may include computing resources such as processing power, memory allocation, cache space, storage space, data files, network connections and/or bandwidth, electrical power, input/output functions, and the like, or data files (e.g., document files, media files, system files, and/or the like). In other embodiments, resources may refer to financial resources such as funds or digital currencies, where such resources may be linked to an account associated with a user.

Embodiments of the present disclosure provide a system for implementing predictive configuration changes based on tracking application usage patterns. In this regard, the system may comprise an intelligent prediction engine that may track user behavior patterns, which may include application usage patterns, resource transfer patterns, online network activity, and/or the like. Based on tracking the user behavior patterns, the system may intelligently predict certain future actions or intent of the user. Upon predicting the future actions or intent, the system may generate and transmit a notification to the user, where the notification comprises one or more proposed configuration changes, where such changes may include modifications to a user account associated with the user, an application installed on the user's device, relationships with third parties, and/or the like. In this regard, the notification may comprise an interactive element that, when selected by the user, may automatically implement such configuration changes.

In one exemplary embodiment, the intelligent prediction engine may collect data on how a particular user is using an application (e.g., what commands or functions are being accessed, which interface elements are being interacted with, at what times the application is being used, how frequently the application and/or its functions are being accessed, and/or the like). In particular, the application may be a resource management application that may be installed on the user's device, where such application is provided by an entity associated with the user, such as a financial institution with which the user may hold a resource account. In such embodiments, the system may further track the activity associated with such resource account, which may include information about resource transfers made using the resource account (e.g., the types of resource transfers made, resource transfer amounts, transfer timeframes and/or frequency, recipient information, and/or the like). The collected data may then be fed into the intelligent prediction engine to serve as training data such that the intelligent prediction engine may learn the various ways certain functions within the application may be used. Based on the collected data, the intelligent prediction engine may then determine the most efficient or optimal path to execute such functions and suggest/implement one or more configuration changes to a user's resource management application and/or resource account based on the optimal path.

Continuing the example, in a given timeframe, the user may use the resource management application to make a series of resource transfers to various third parties on an ad-hoc basis, where such resource transfers are made using a workflow or process flow specific to the user within the application. For instance, the system may detect that the user accesses a particular series of interface element to access a certain sequence screens in order to execute the series of resource transfers. Furthermore, the system may detect an inefficiency in the workflow of the user by comparing the workflow of the user with the most efficient path determined by the system based on the aggregated data. In one example, the user may neglect to use a particular feature or function of the application that may increase the efficiency of the user's workflow (e.g., a batch resource transfer function or automated recurring transfer function). In such cases, the system may generate and present a notification on the device of the user, where the notification includes a recommendation for a configuration change (e.g., in the application and/or account settings associated with the user) to increase the efficiency of the user's workflow (e.g., by enabling the automated recurring transfer function).

In addition to the recommendation, the notification may include a prompt to the user to provide authorization for implementing the configuration change. The prompt may be accompanied by an interactable element within the notification (e.g., an interactive link, button, selectable area, and/or the like) that, when activated by the user, may automatically implement the configuration change. For instance, the interactable element may enable certain functions or features associated with the user's account (e.g., executing a batch resource transfer on behalf of the user.) In this way, the system may reduce the inefficiencies of user behaviors within the resource management application.

In some embodiments, the system may further make recommendations to the user based on historical data associated with the user's resource account. In this regard, the system may learn the user's preferences and/or behaviors with respect to resource transfers (e.g., the types of transactions executed by the users, types or categories of services or products purchased, the identity of vendors or providers, payment methods, and/or the like). In such embodiments, the recommendations provided to the user may include suggestions for opportunities to purchase certain goods or services offered by certain providers, according to the behaviors and preferences of the user.

For example, the system may feed identifying information about the user (e.g., the user's occupation, interests, life stages, investments, finances, and/or the like) into the intelligent prediction engine, which may then generate one or more predictions regarding intended actions of the user. For instance, based on the data associated with the user, the intelligent prediction engine may predict that the user intends to purchase a particular good or service (e.g., based on detecting the life stage and/or occupation of the user, the system determines that the user will enroll in a university and dance lessons). Accordingly, the system may transmit a notification to the user comprising recommendations to begin the onboarding process related to such good or service. The notification may further comprise a prompt to approve an automated onboarding process, where the prompt includes an interactable element. Once the user activates the interactable element, the system may automatically implement the recommendations to onboard the user with the selected vendor (e.g., by generating new entitlements for the user, creating payment channels, registering a user account with the vendor, and/or the like). In this way, the system may intelligently tailor the experiences of the user based on aggregating the data associated with the user.

The system as described herein provides a number of technological benefits over conventional resource transfer systems. In particular, by combining the recommendations with an automated process for implementing configuration changes based on the recommendations, the system may increase the efficiency with which users use applications as well as the various functions associated with their resource accounts. In turn, the computing systems that host the applications may save on computing resources associated with correcting the inefficiencies, which may include processing power, network bandwidth, memory space, and/or the like.

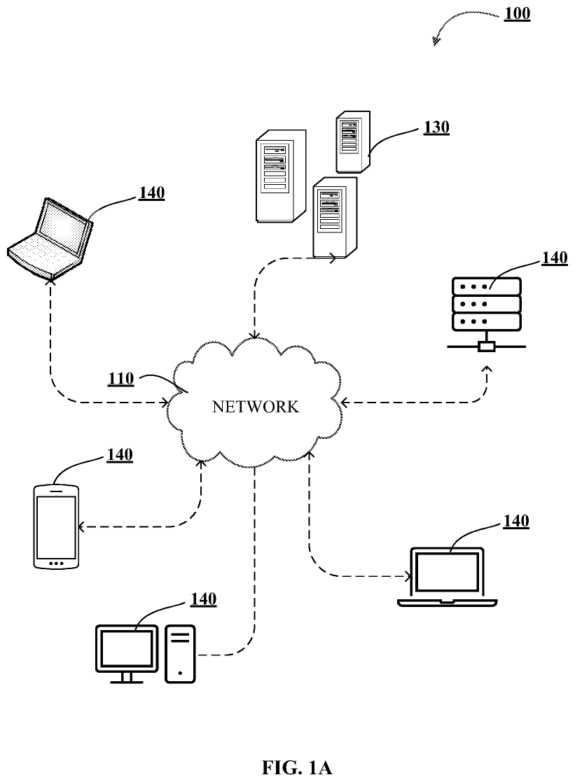

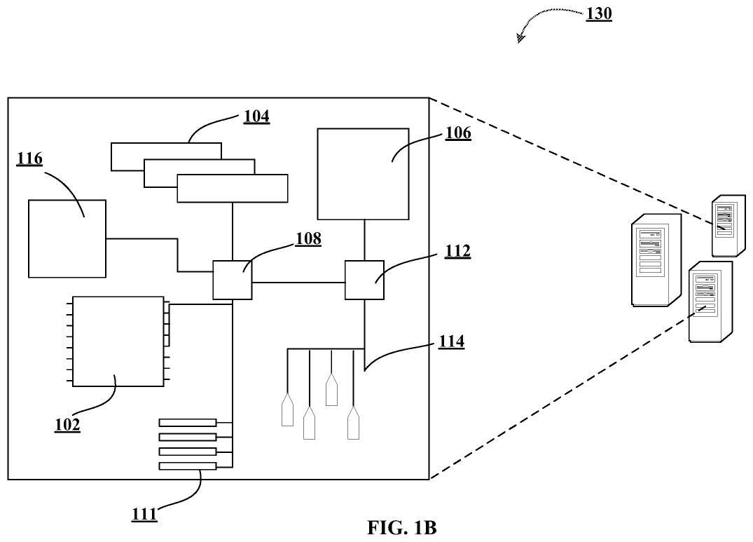

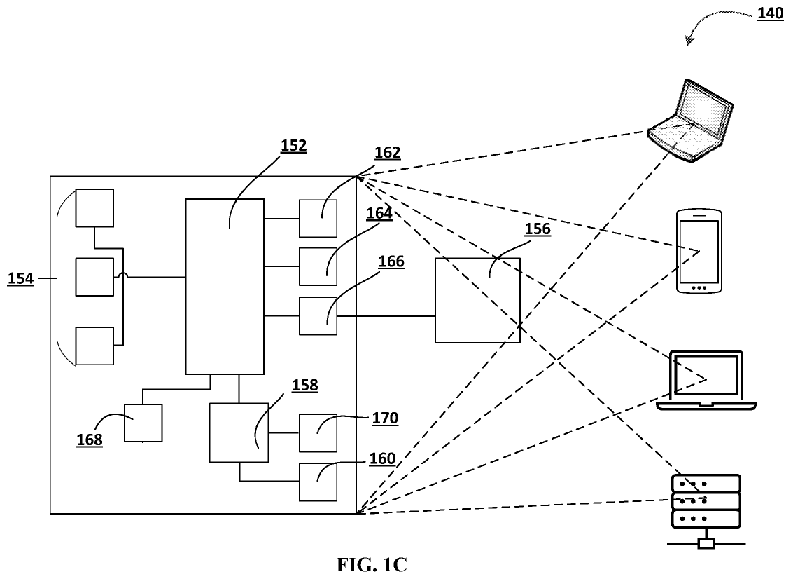

FIGS. 1A-1C illustrate technical components of an exemplary distributed computing environment 100 for the system for implementing predictive configuration changes based on tracking application usage patterns. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. For instance, the functions of the system 130 and the endpoint devices 140 may be performed on the same device (e.g., the endpoint device 140). Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it. In some embodiments, the system 130 may provide an application programming interface (“API”) layer for communicating with the end-point device(s) 140.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as servers, networked storage drives, personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the inventions described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert it to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

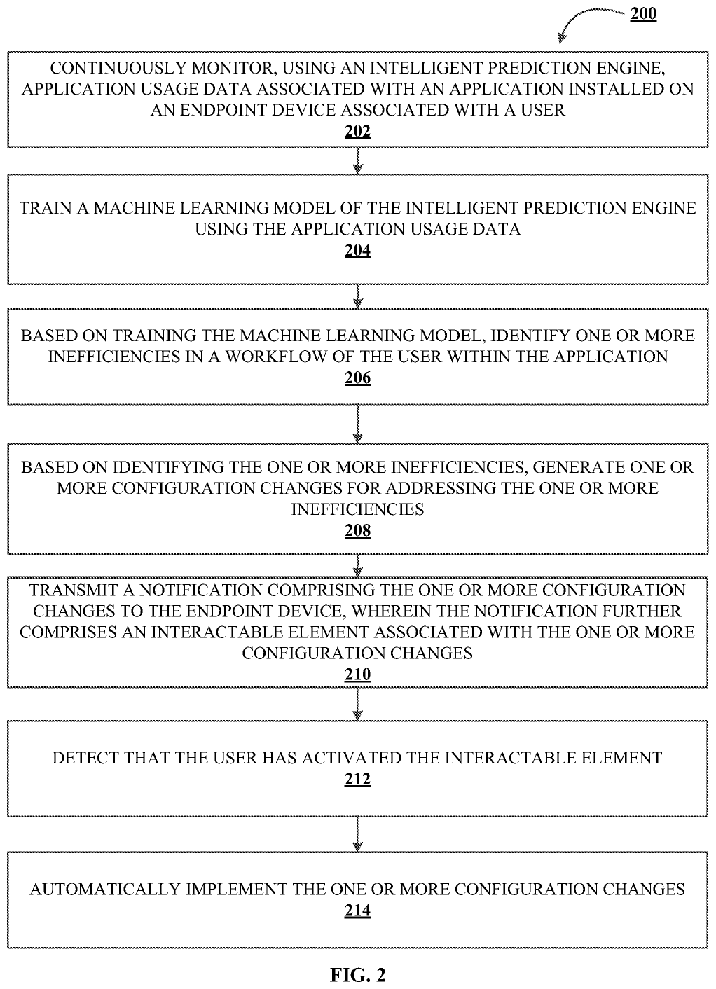

FIG. 2 illustrates a process flow 200 for implementing predictive configuration changes based on tracking application usage patterns, in accordance with an embodiment of the present disclosure. The process begins at block 202, where the system continuously monitors, using an intelligent prediction engine, application usage data associated with an application installed on an endpoint device associated with a user. In this regard, the application usage data may include information regarding how the user is using the application. Accordingly, the application usage data may include information on what functions the user is accessing within the application, what interface elements the user interacts with, the timeframes in which the user access the application, and/or the like. In some embodiments, the application installed on the endpoint device may be a resource management application for managing a resource account associated with the user. In such embodiments, the system may further track resource account data, which may include information such as resource transfer data associated with the resource account, which may include information such as types and/or purposes for the resource transfers, resource transfer amounts, resource transfer timeframes and/or resource transfer frequency, recipient information for the resource transfers, and/or the like. Accordingly, in some embodiments, the system may generate recommendations based on the resource account data along with the application usage data.

The process continues to block 204, where the system trains a machine learning model of the intelligent prediction engine using the application usage data. By aggregating the application usage data of all users within the system, the intelligent prediction engine may be trained to recognize the various ways in which users may use the application. Accordingly, by analyzing the application usage data, the intelligent prediction engine may determine the most efficient processes for accomplishing the user's intended actions within the application (e.g., using the features of the application). The analysis of the intelligent prediction engine may then in turn be used to drive the decisioning processes for generating recommendations and/or implementing configuration changes.

The process continues to block 206, where the system, based on training the machine learning model, identifies one or more inefficiencies in a workflow of the user within the application. In this regard, the system may intelligently predict the intention of the user behind the workflow (e.g., the user's intended action within the application or what functionality the user is attempting to use within the application) and, based on comparing the workflow of the user with the most efficient process for using a particular function, the system may determine what inefficiencies exist within the workflow of the user. For instance, the inefficiency may include leaving a particular application setting disabled or not using a particular included feature within the application.

The process continues to block 208, where the system, based on identifying the one or more inefficiencies, generates one or more configuration changes for addressing the one or more inefficiencies. The configuration changes may depend on the particular inefficiencies identified within the workflow of the user. For instance, the configuration changes may include a change to application settings (e.g., enabling a particular setting on an application) the use of a particular application feature (e.g., a macro feature or automated recurring action feature). In an exemplary embodiment, the user may be executing various resource transfers to multiple recipients through the application on an ad-hoc basis. In such an embodiment, the recommended configuration change may include the usage of a batch transfer function and/or use of an automated recurring resource transfer function. Accordingly, once the one or more configuration changes are implemented, the inefficiencies in the user's workflow may be remediated.

The process continues to block 210, where the system transmits a notification comprising the one or more configuration changes to the endpoint device, wherein the notification further comprises an interactable element associated with the one or more configuration changes. The notification may comprise a prompt to the user to review and accept the configuration changes proposed in the notification. Accordingly, such a prompt may be accompanied by the interactable element, which may be a graphical interface element such as a button, selectable area for touch input, radio button, check button, and/or the like. By selecting the interactable element, the user may provide an authorization or approval to implement the configuration changes.

The process continues to block 212, where the system detects that the user has activated the interactable element. In an exemplary embodiment, the notification may include a recommendation for the user to implement a recurring resource transfer based on the behavior patterns of the user within the application (e.g., the user transfers resources to certain recipients on a frequent or regular basis). In such an embodiment, the notification may notify the user that the recurring resource transfer function is available within the application and further request authorization to implement the configuration change. Accordingly, upon detecting that the system has selected the interface element (e.g., the user has clicked a button that may be labeled “Yes”), the system may determine that the user has accepted the configuration change.

The process continues to block 214, where the system automatically implements the one or more configuration changes. Automatically implementing the configuration change may depend on the nature of the configuration change. For instance, if the configuration change concerns the application installed on the endpoint device, the system may automatically modify the settings of the application to implement the configuration change. In scenarios in which the configuration change concerns the resource account of the user, the system may automatically perform additional processes (e.g., generating new user entitlements, establishing relationships between the user and potential service providers, and/or the like). In this way, the system may optimize the user's experience both in using the application and the resource account.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for implementing predictive configuration changes based on tracking application usage patterns, the system comprising:
at least one non-transitory storage device; and
at least one processor coupled to the at least one non-transitory storage device, wherein the at least one processor is configured to:
continuously monitor, using an intelligent prediction engine, application usage data associated with an application installed on an endpoint device associated with a user;
train a machine learning model of the intelligent prediction engine using the application usage data;
based on training the machine learning model, identify one or more inefficiencies in a workflow of the user within the application;
based on identifying the one or more inefficiencies, generate one or more configuration changes for addressing the one or more inefficiencies;
transmit a notification comprising the one or more configuration changes to the endpoint device, wherein the notification further comprises an interactable element associated with the one or more configuration changes;
detect that the user has activated the interactable element; and
automatically implement the one or more configuration changes.

2. The system of claim 1, wherein identifying the one or more inefficiencies in the workflow of the user comprises:
feeding the application usage data into the intelligent prediction engine;
based on the application usage data, determining a most efficient process flow for accomplishing an intended action of the user within the application; and
comparing the most efficient process flow with the workflow of the user.

3. The system of claim 1, wherein the application usage data comprises information on application functions accessed by the user, which interface elements the user has interacted with, and what timeframes in which the user has accessed the application.

4. The system of claim 1, wherein the one or more inefficiencies in the workflow comprises a disabled application setting, wherein the one or more configuration changes comprises automatically enabling the application setting.

5. The system of claim 1, wherein the application is a resource management application, wherein the intelligent prediction engine is further configured to monitor resource account data associated with the user.

6. The system of claim 5, wherein the resource account data comprises resource transfer data, the resource transfer data comprising resource transfer amounts, recipient data, and resource transfer timeframes.

7. The system of claim 1, wherein the notification further comprises a prompt for the user to accept the one or more configuration changes.

8. A computer program product for implementing predictive configuration changes based on tracking application usage patterns, the computer program product comprising a non-transitory computer-readable medium comprising code causing an apparatus to:
continuously monitor, using an intelligent prediction engine, application usage data associated with an application installed on an endpoint device associated with a user;
train a machine learning model of the intelligent prediction engine using the application usage data;
based on training the machine learning model, identify one or more inefficiencies in a workflow of the user within the application;
based on identifying the one or more inefficiencies, generate one or more configuration changes for addressing the one or more inefficiencies;
transmit a notification comprising the one or more configuration changes to the endpoint device, wherein the notification further comprises an interactable element associated with the one or more configuration changes;
detect that the user has activated the interactable element; and
automatically implement the one or more configuration changes.

9. The computer program product of claim 8, wherein identifying the one or more inefficiencies in the workflow of the user comprises:
feeding the application usage data into the intelligent prediction engine;
based on the application usage data, determining a most efficient process flow for accomplishing an intended action of the user within the application; and
comparing the most efficient process flow with the workflow of the user.

10. The computer program product of claim 8, wherein the application usage data comprises information on application functions accessed by the user, which interface elements the user has interacted with, and what timeframes in which the user has accessed the application.

11. The computer program product of claim 8, wherein the one or more inefficiencies in the workflow comprises a disabled application setting, wherein the one or more configuration changes comprises automatically enabling the application setting.

12. The computer program product of claim 8, wherein the application is a resource management application, wherein the intelligent prediction engine is further configured to monitor resource account data associated with the user.

13. The computer program product of claim 12, wherein the resource account data comprises resource transfer data, the resource transfer data comprising resource transfer amounts, recipient data, and resource transfer timeframes.

14. A computer-implemented method for implementing predictive configuration changes based on tracking application usage patterns, the computer-implemented method comprising:
continuously monitoring, using an intelligent prediction engine, application usage data associated with an application installed on an endpoint device associated with a user;
training a machine learning model of the intelligent prediction engine using the application usage data;
based on training the machine learning model, identifying one or more inefficiencies in a workflow of the user within the application;
based on identifying the one or more inefficiencies, generating one or more configuration changes for addressing the one or more inefficiencies;
transmitting a notification comprising the one or more configuration changes to the endpoint device, wherein the notification further comprises an interactable element associated with the one or more configuration changes;
detecting that the user has activated the interactable element; and
automatically implementing the one or more configuration changes.

15. The computer-implemented method of claim 14, wherein identifying the one or more inefficiencies in the workflow of the user comprises:
feeding the application usage data into the intelligent prediction engine;
based on the application usage data, determining a most efficient process flow for accomplishing an intended action of the user within the application; and
comparing the most efficient process flow with the workflow of the user.

16. The computer-implemented method of claim 14, wherein the application usage data comprises information on application functions accessed by the user, which interface elements the user has interacted with, and what timeframes in which the user has accessed the application.

17. The computer-implemented method of claim 14, wherein the one or more inefficiencies in the workflow comprises a disabled application setting, wherein the one or more configuration changes comprises automatically enabling the application setting.

18. The computer-implemented method of claim 14, wherein the application is a resource management application, wherein the intelligent prediction engine is further configured to monitor resource account data associated with the user.

19. The computer-implemented method of claim 18, wherein the resource account data comprises resource transfer data, the resource transfer data comprising resource transfer amounts, recipient data, and resource transfer timeframes.

20. The computer-implemented method of claim 14, wherein the notification further comprises a prompt for the user to accept the one or more configuration changes.
